(19) United States
(12) Patent Application Publication
(10) Pub. No.: US 2024/0246180 A1
(43) Pub. Date: Jul. 25, 2024

(54) Orbital Welding System

(71) Applicant: Hoffman Instrumentation Supply, Inc., Hillsboro, OR (US)

(72) Inventors: Max Steven Miille, Hillsboro, OR (US); Chad Cook, Hillsboro, OR (US)

(73) Assignee: Hoffman Instrumentation Supply, Inc., Hillsboro, OR (US)

(21) Appl. No.: 18/421,383

(22) Filed: Jan. 24, 2024

Related U.S. Application Data
(60) Provisional application No. 63/481,587, filed on Jan. 25, 2023.

(51) Int. Cl. B23K 37/02; B23K 9/028; B23K 9/167

(52) U.S. Cl. CPC B23K 37/0276; B23K 9/0284; B23K 9/167; B23K 37/0241; B23K 37/0247

(57) ABSTRACT

An orbital welding system is suitable for welding a flange to a tube. The system includes a base having a main axis and a clamp assembly configured to demountably secure a flange to the base. A mount is coupled to the base and rotatable about the main axis. A welding torch is coupled to the mount and includes electrode that extends radially outward from the main axis. The system further includes a motor configured to drive rotation of the mount about the main axis.

### CROSS-REFERENCE TO RELATED APPLICATION

This application claims the benefit of Provisional Application No. 63/481,587, filed Jan. 25, 2023, the entire disclosure of which is hereby incorporated by reference herein for all purposes.

### BACKGROUND

Vacuum system components, such as tubes, pipes, vacuum chambers, and pumps often utilize vacuum flanges coupled to the components to provide maintain a vacuum seal between the components. For example, to connect pipes together with a vacuum seal, a flange may be attached to the end of each tube such that the flange extends radially around outward from the end of the tube. An elastomeric seal, such an O-ring, is positioned between the flanges, and the flanges are then secured to each other by a clamp. The clamp compresses the seal between the flanges and also aligns the flanges, and therefore, the tubes, with each other. With the clamp engaging both flanges, a vacuum-tight seal is formed between the interior portions of the tubes. The clamps enable easy assembly and disassembly of the joint.

Vacuum flanges are often mounted to a corresponding tube by welding. For aluminum tubes and flanges, Tungsten Inert Gas (TIG) welding may be utilized. Orbital welders are often employed, wherein the tube is clamped in a stationary position, and the welding tool is rotated around the outside of the circumference of the tube to provide a circumferential weld that secures the flange to the tube. A drawback of known orbital welders is that tubes with flanges on two different geometric centers cannot spin around the same axis to achieve a consistent fusion weld.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Disclosed embodiments of an orbital welding system are suitable for welding a flange to a tube. The systems secure a flange relative to a welding torch. A tube is mounted to the flange, and the welding torch is driven to produce a welding bead along an inner interface of the flange with the tube. In an embodiment, the system includes a base having a main axis and a clamp assembly configured to demountably secure a flange to the base. A mount is coupled to the base and rotatable about the main axis. A welding torch is coupled to the mount and includes electrode that extends radially outward from the main axis. The system further includes a motor configured to drive rotation of the mount about the main axis.

In any embodiment, the system further includes a drive gear coupled to the motor for selective rotation about a drive axis; a main gear fixedly positioned relative to the mount and engaging the drive gear such that rotation of the drive gear about the drive axis in a first direction rotates the welding torch about main axis in a second direction.

In any embodiment, the clamp assembly is configured to center the flange along the main axis.

In any embodiment, the clamp assembly comprises at least one clamping element, wherein each of the at least one clamping elements includes a clamp member rotatably coupled to the base about a clamp axis such that rotation of the clamp member in a first direction about the clamp axis moving a first end of the clamp member toward the base; and a drive element selectively positionable relative to the base and engaging the clamp member to selectively rotate the clamp member about the clamp axis.

In any embodiment, each of the at least one clamping elements further includes a biasing element configured to urge the first end of the clamp member away from the base.

In any embodiment, the drive element is a screw in threaded engagement with the base.

In any embodiment, the clamp assembly includes at least one elongate clamp element mounted to the base for rotation about a corresponding clamp axis, the clamp axis being parallel to the main axis; and a drive element engaging each of the at least one clamp elements to selectively rotate the clamp element about the corresponding clamp axis between a clamped position and an unclamped position.

In any embodiment, the drive element is a clamp ring mounted to the base for selective rotation about the main axis, the clamp ring driving each of the at least one clamp elements about the corresponding clamp axis.

In any embodiment, the clamp ring includes at least one pin mounted thereto, each of the at least one pins extending through a slot formed in a corresponding one of the at least one claim elements, movement of each of the at least one pin around the main axis driving rotation of the corresponding clamp element about the corresponding clamp axis.

In any embodiment, the system further includes a plurality of mounting tabs coupled to the base, each mounting tab limiting rotation of at least one of the clamp elements.

In any embodiment, at least one handle extends radially from the clamp ring.

In any embodiment, the system further includes a guide fixedly positioned relative to the base, the guide limiting rotation of the clamp ring about the main axis.

In any embodiment, the welding torch is a TIG welding torch.

In any embodiment, the rotation of the mount drives the electrode along a circular path.

In any embodiment, the circular path is offset from the base.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a top isometric view of an embodiment of an orbital welding assembly according to aspects of the present disclosure;

FIG. 2 shows a top view thereof;

FIG. 3 shows a side cross-sectional view thereof as indicated in FIG. 2;

FIG. 4 shows a side cross-sectional view thereof as indicated in FIG. 2;

FIG. 5 shows a partial bottom isometric view thereof;

FIG. 6 shows a top isometric view of another embodiment of an orbital welding assembly according to aspects of the present disclosure;

FIG. 7 shows a bottom perspective view thereof;

FIG. 8 shows a bottom view thereof with a clamping assembly in a locked state;

FIG. 9 shows a bottom view thereof with a portion of the clamping assembly removed;

FIG. 10 shows a bottom view thereof with a portion of the clamping assembly removed and the clamping assembly in an unlocked state;

FIG. 11 shows a detailed view of a clamping element of the clamping assembly indicated in FIG. 9, and

FIG. 12 shows a cross-sectional view of the orbital welding assembly as indicated in FIG. 8.

### DETAILED DESCRIPTION

Described embodiments of Orbital Flange Welders OFWs are capable of welding common industry standard flanges to tubes, pipes, vacuum system components, or any other conduits that require a connection capable of a leak-proof connection. Each OFW is capable of fitting common industry standard flanges Kwik Flange (KF) and International Standard Flange (ISO). The OFW provides consistent fusion weld that allows the operator to achieve a high repeatability and a low leak test failure rate. The OFW is an automated welder that can be used in various positions. The OFW system is capable of welding tubes with flanges on different geometric centers because the OFW provides an automated weld that can be done in all positions by rotating the welding torch instead of rotating the tube.

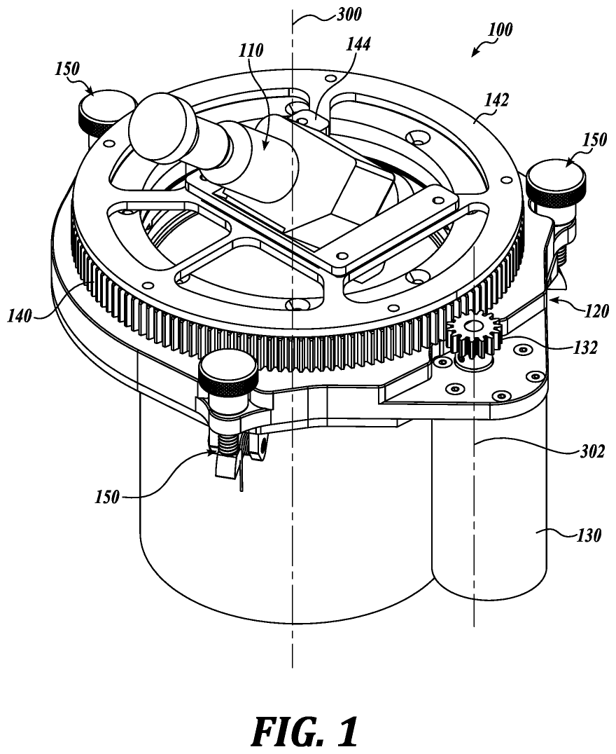

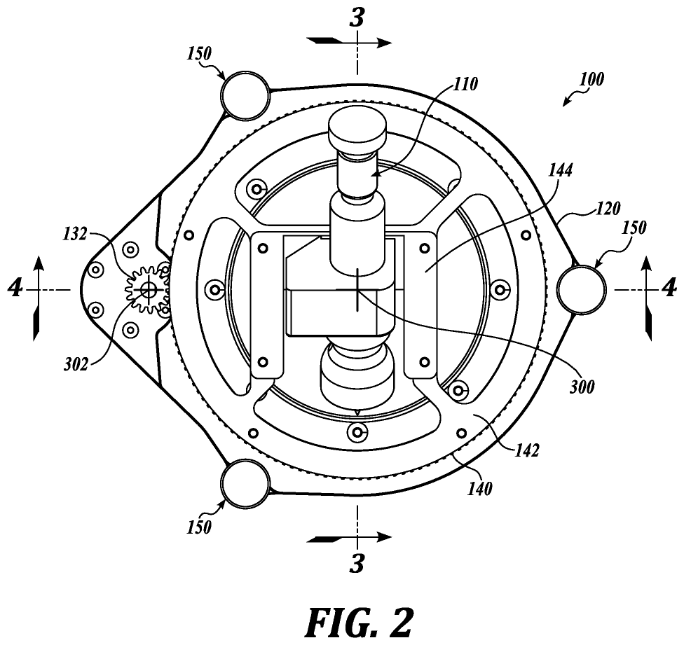

FIGS. 1-5 show an embodiment of an orbital welding system 100 according to aspects of the present disclosure. As will be explained in further detail, the system 100 rotates a welding torch 110 about an axis 300 to produce a circumferential weld around an interior portion of a tube or pipe. The system 100 is particularly suitable for welding flanges ISO style flanges to tubes, although the system is not limited to this particular style of flange.

The system 100 includes a generally flat base 120 with a motor 130 mounted thereto. A drive gear 132 (pinion) is coupled to an output shaft of the motor 130 to be selectively rotatably about an axis 302. A main gear 140 is mounted to the base 120 to be rotatable about axis 300. The drive gear 132 is operable engaged with the main gear 140 so that the motor 130 selectively drives rotation of the main gear about axis 300 by rotating the drive gear about axis 302. In some embodiments, the drive gear 132 and main gear 140 are spur gears, helical gears, or any other gears suitable. In some embodiments, axes 300 and 302 are parallel, and the drive gear 132 directly engages the main gear 140. In some embodiments, any suitable motor and transmission selectively rotates the main gear 140 about axis 300.

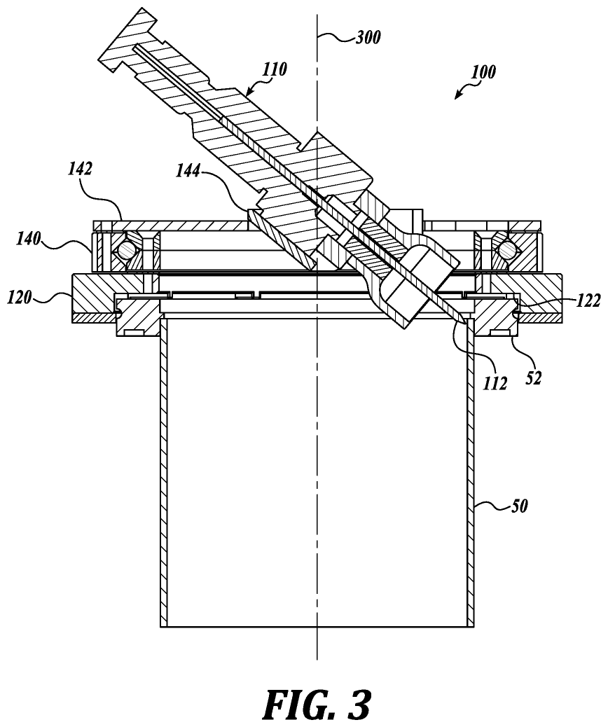

A mounting plate 142 is mounted to an upper surface of the main gear 140 and includes a mount 144 sized and configured to have welding torch 110 mounted thereto. As best shown in FIGS. 1 and 3, when mounted to the mount 144, the welding torch 110 is positioned at an angle relative to axis 300. When the main gear 140 rotates about axis 300, the electrode 112 of the welding torch 110 follows a circular path in a plane perpendicular to axis 300. More specifically, the orientation of the mounted welding torch 110 is such that the electrode 112 of the welding torch 110 is proximate to an interior interface of a pipe 50 and a flange fitting 52 to be connected to the pipe. In contrast to known orbital welders, the angle of the welding torch 110 relative to the axis 300 of rotation enables the electrode 112 to extend into the pipe 50 to provide a weld on the interior surface of the pipe.

Referring again to FIGS. 1-5, the system 100 includes a plurality of clamp assemblies 150 mounted to the base 120. The clamp assemblies 150 are positioned circumferentially around axis 300 and are configured to demountable couple a flange fitting 52 to the base 120.

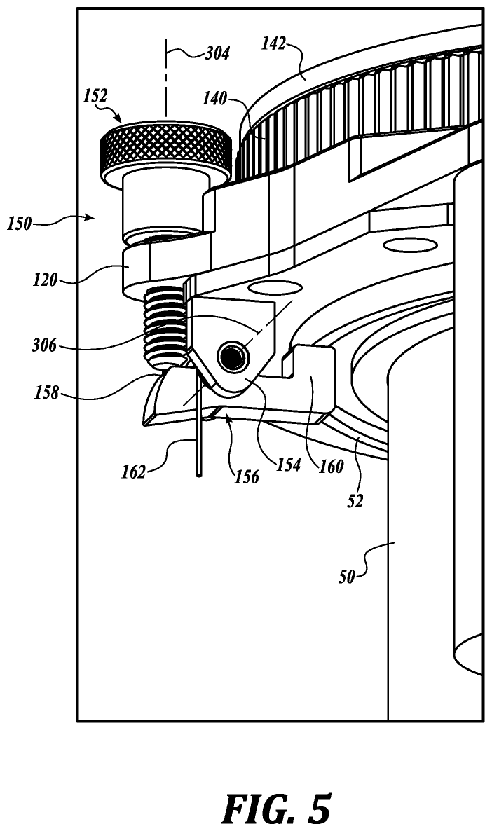

As best shown in FIG. 5, each clamp assembly 150 includes a thumbscrew 152 in threaded engagement with the base 120 and configured for rotation about an axis 304. Rotation of the thumbscrew 152 translates the thumbscrew along axis 304 relative to the base 120. A clevis 154 is mounted to a lower portion of the plate and defines an axis 306. An elongate clamping member 156 is rotatably mounted to the clevis 154 about axis 306. The clamp assembly 150 further includes a biasing element 162, such as a torsion spring, that urges the clamping member 156 to rotate about axis 306 so that a first end 158 of the clamping member maintains contact with the thumbscrew 152 (clockwise as shown in FIG. 5).

To mount the system 100 to a flange fitting 52, the system is positioned such that the flange fitting is positioned within a recess 122 formed in the bottom surface of the base 120. Each clamp assembly 150 is then moved from an unclamped state to a clamped state. To move clamp assembly 150 to the clamped state, the thumbscrew 152 is rotated to move the thumbscrew relative to the base 120 and toward the clamping member 156. The thumbscrew 152 drives the first end 158 of the clamping member 156 away from the base, which rotates the clamping member about axis 306 (counter-clockwise in FIG. 5). Rotation of the clamping member 156 drives a second end 160 of the clamping member toward the base 120 until the second end of the clamping member engages the flange of the flange fitting 52. With all of the clamp assemblies 150 in the clamped state, the flange fitting 52 is secured within the recess in the base 120 by the engagement of the clamping members 156 with the flange of the flange fitting.

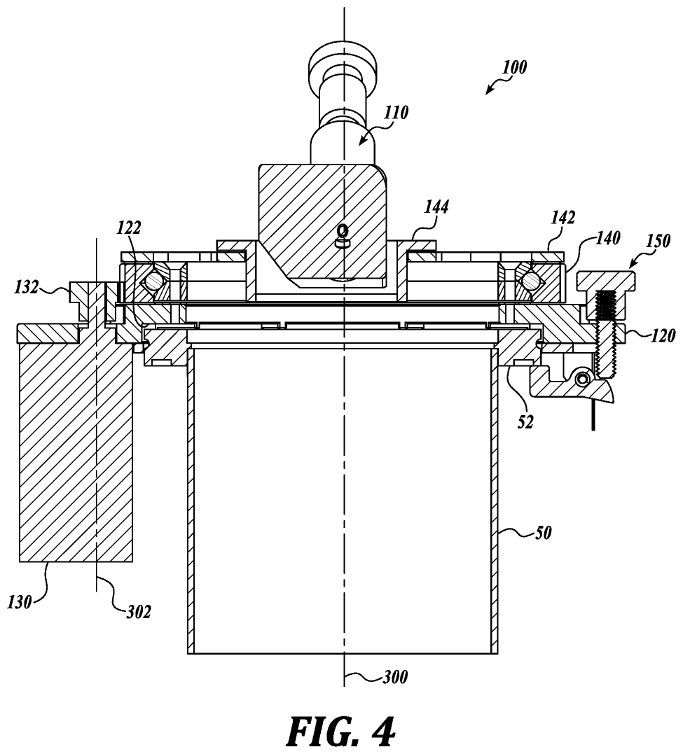

Referring again to FIGS. 3 and 4, with system 100 mounted to the flange fitting 52, a tube 50 is positioned relative to the flange fitting 52. In the illustrated embodiment, the tube 50 is partially received within the flange fitting 52, however, any suitable configuration for position a tube for welding to a flange fitting can be employed. With the flange fitting 52 secured to the base 120 and the tube 50 positioned relative to the flange fitting, the motor 130 drives rotation of the welding torch 110 so that the electrode 112 follows a circular path proximate to the interface of the tube 50 and the flange fitting 52. During this rotation, the welding torch 110 creates a weld bead along the interface to weld the flange fitting 52 to the tube 50.

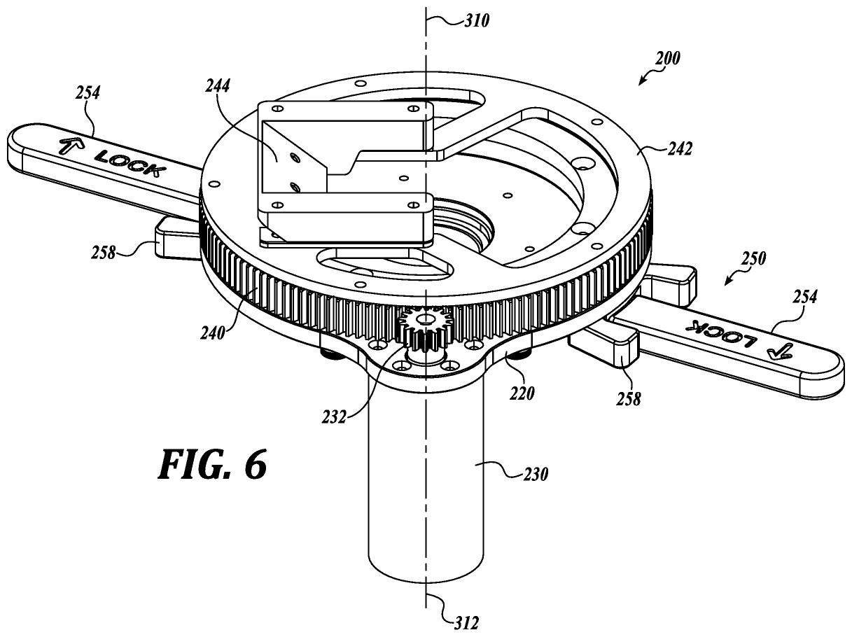

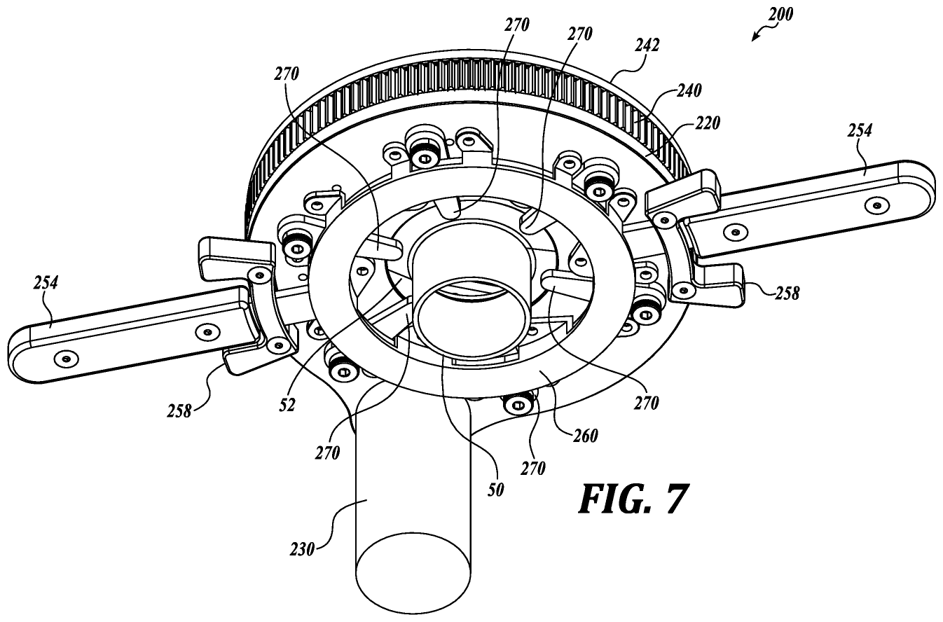

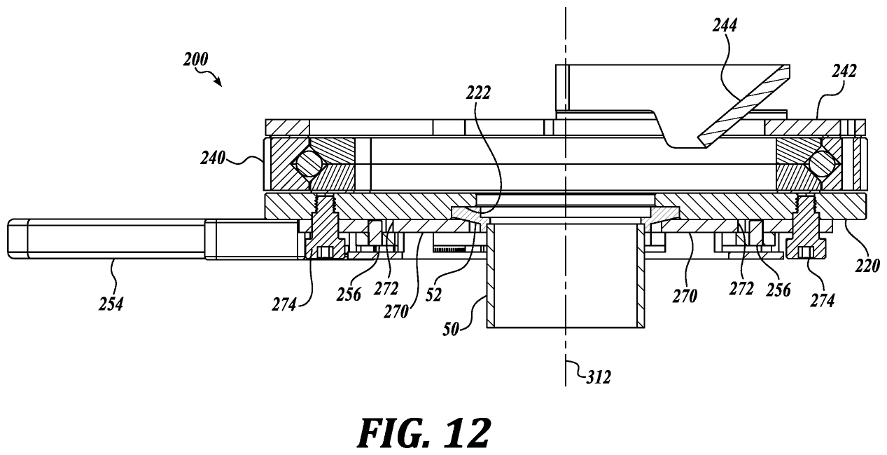

Referring now to FIGS. 6-12, another representative embodiment of an orbital welding system 200 according to aspects of the present disclosure will be described. The system 200 is particularly suitable for welding flanges KF style flanges to tubes, although the system is not limited to this particular style of flange.

The system 200 is similar to the system 100 shown in FIGS. 1-5 except for the clamp assembly 250. In this regard, the system 200 includes a generally flat base 220 with a motor 230 mounted thereto. A drive gear 232 (pinion) is coupled to an output shaft of the motor 230 to be selectively rotatably about an axis 310. A main gear 240 is mounted to the base 220 to be rotatable about axis 310. The drive gear 232 is operable engaged with the main gear 240 so that the motor 230 selectively drives rotation of the main gear about axis 310 by rotating the drive gear about axis 312. In some embodiments, the drive gear 232 and main gear 240 are spur gears, helical gears, or any other gears suitable. In some embodiments, axes 310 and 312 are parallel, and the drive gear 232 directly engages the main gear 240. In some embodiments, any suitable motor and transmission selectively rotates the main gear 240 about axis 310.

A mounting plate 242 is mounted to an upper surface of the main gear 240 and includes a mount 244 sized and configured to have welding torch (not shown) mounted thereto. Similar to the embodiment shown in FIGS. 1 and 3, when mounted to the mount 244, the welding torch is positioned at an angle relative to axis 310. When the main gear 240 rotates about axis 310, the electrode of the welding torch follows a circular path in a plane perpendicular to axis 310. More specifically, the orientation of the mounted welding torch is such that the electrode of the welding torch is proximate to an interior interface of a pipe 50 and a flange fitting 52 to be connected to the pipe. In contrast to known orbital welders, the angle of the welding torch relative to the axis 310 of rotation enables the electrode to extend into the pipe 50 to provide a weld on the interior surface of the pipe.

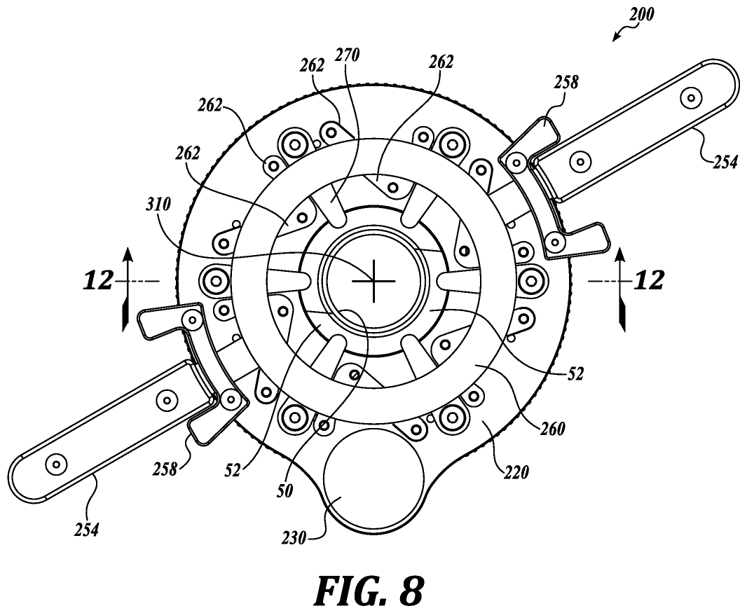

A clamp assembly 250 selectively secures a flange fitting 52 to the base 220. As best shown in FIGS. 8-11, the clamp assembly 250 includes a clamp ring 252 mounted to the base 220 and rotatable about axis 310. A cage 260 is mounted to the bottom of the base 220 and has a main portion offset from the base to define a space between the main portion and the base. The clamp ring 252 is disposed within this space and retained by mounting tabs 262 that secure the cage 260 to the base 220.

One or more handles 254 extend radially from the clamp ring 252. At least one of the handles 254 extends through a guide 258 mounted to the base 220. The guide 258 includes a pair of stops that limit rotation of the handles 254 and, thus, the clamp ring 252 in both directions.

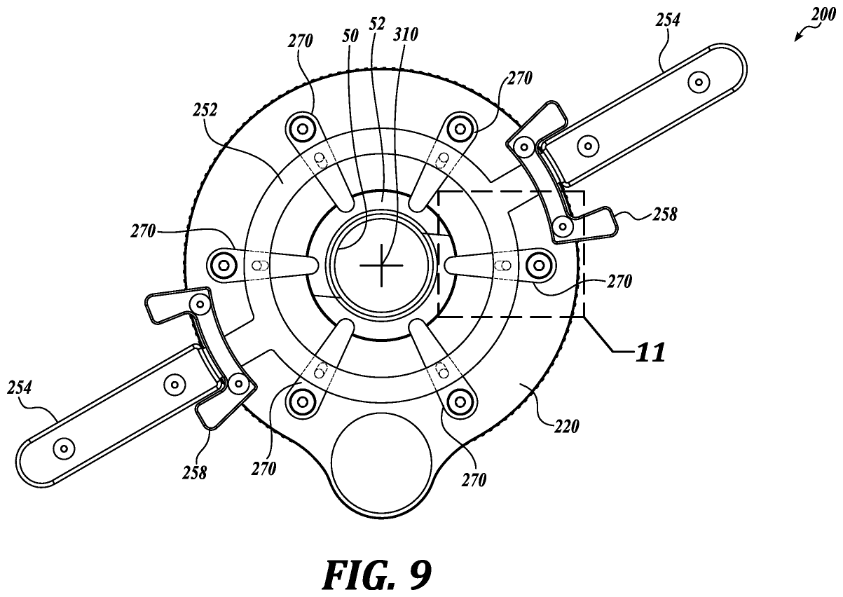

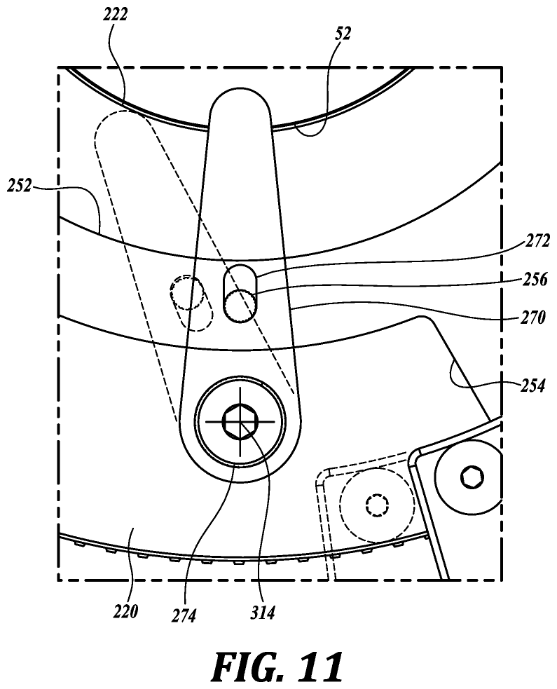

Referring now to FIGS. 9-11, wherein the cage 260 is removed for clarity, each of a plurality of elongate clamping elements 270 is rotatably coupled to the base 220 by a pin 274. As best shown in FIG. 11, each clamping element 270 is configured for rotation about an axis 314 that is fixedly positioned relative to the base. A slot 272 is formed in each clamping element 270, and a pin 256 extends from the clamp ring 252 to slidingly engage the slot 272. As the clamp ring is rotated, each pin 256 moves relative to the axis 314 of the corresponding clamping element 270 to rotate the clamping element about the corresponding axis 314. Movement of the pin 256 within the slot 272 accommodates the changing distance between axis 314 and the corresponding pin 256.

In FIG. 9, the clamp assembly 250 is in the clamped state. In this regard, each clamping element 270 extends radially inward to engage the flange fitting 52. More specifically, the flange fitting 52 is positioned within a recess 222 formed in the base 220 (see FIG. 11), and the clamping elements 270 engage the flange fitting 52 to retain the flange fitting within the recess.

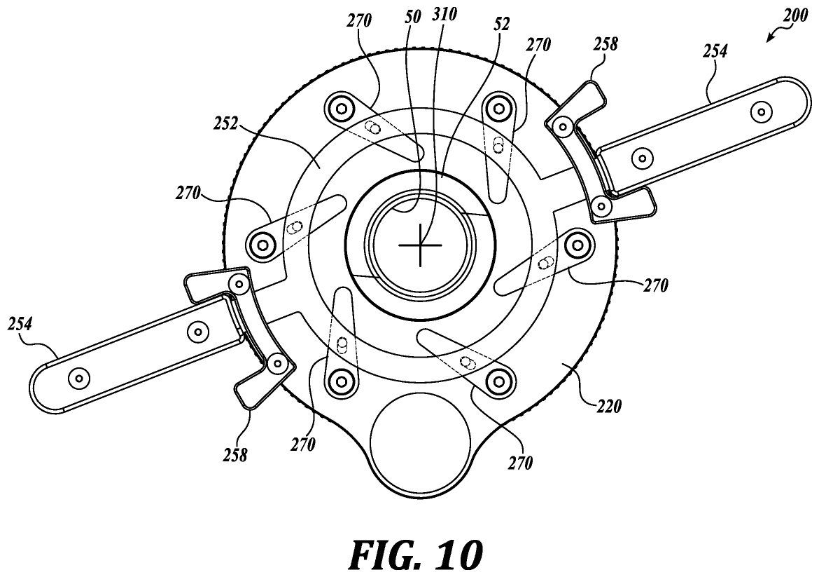

In FIG. 10, the claim assembly 250 is in the unclamped state. In the unclamped state, each clamping element 270 has been rotated about its respective axis 314 to disengage the flange fitting 52. Further, the clamping elements 270 do not extend over the edge of the recess 222, so a flange fitting 52 can be inserted into or removed from the recess.

To move the clamp assembly 250, an operator rotates the clamp ring 252 by turning the handles 254 clockwise and counter-clockwise. More specifically, moving the handles 254 in the counterclockwise direction (as viewed in FIG. 9) puts the clamp assembly 250 in the clamped state of FIG. 9. Moving the handles 254 in the clockwise direction (as viewed in FIG. 10) puts the clamp assembly 250 in the unclamped state of FIG. 10.

To operate embodiments the OFW, an operator places the OFW onto an assembled flange and tube and clamps the OFW to the flange. The operator powers on the motor in the desired direction. Once the torch is moving, the operator hits the trigger button to start the weld timer. After the weld is done, the operator turns off the power to the motor, unclamps the OFW, and removes the OFW from the flange. The OFW is placed onto a cooling station and an air valve is opened to start air cooling the OFW.

Embodiments of the disclosed OFW provide at least the following advantages over known orbital welding systems:

Provides accurate and repeatable welds. Fully automated system that produces consistent high-quality welds.

Allows operator to clamp and weld a flange to a multifaceted and complex tube without moving/rotating the tube on an axis.

Allows operator to quickly detach torch mounting head to change flange sizes. Operators can quickly and easily change OFW systems to weld a range of common ISO or KF flanges.

Allows operator to weld in the field or at a bench with same results.

Welds can be inspected in the fixture.

Standard orbital weld heads only weld tube to tube, whereas this welds flanges to tubes. Does not require a half nipple (flange to tube). Welds flange straight to tube.

Welds can be performed at any angle, even upside-down.

Outside corner joint is an easier type of joint to weld than a full penetration butt weld.

Does not require back purging because it is not a full penetration weld.

The OFW is the only known fully automated flange welder. The most similar process that is a quite common alternative is an orbital tube welder. That process clamps two tubes in line with each other and performs a butt connection full penetrating weld. This type of weld requires the tube to be fully back purged and uses a half nipple with the flange already welded on it. The OFW does not require back purging because the joint is an outside corner joint and does not fully penetrate. The OFW does not require a half nipple either because it welds the ISO or KF flanges directly onto the tube.

The OFW system may have different types of clamping mechanisms to secure the OFW to the different types of flanges to be welded. In one non-limiting example, the ISO style clamp mechanism has the 3 pivot hooks that operator engages by screwing the knurled threaded knobs. In another non-limiting example, the KF style has the turn plate mechanism that the operator turns the two handles to simultaneously turn clamping elements.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure.

The embodiments of the invention in which an exclusive property or privilege is claimed are defined as follows:

1. An orbital welding system for welding a flange to a tube, the system comprising:
a base having a main axis;
a clamp assembly configured to demountably secure a flange to the base;
a mount coupled to the base and rotatable about the main axis;
a welding torch coupled to the mount, the welding torch having an electrode that extends radially outward from the main axis; and
a motor configured to drive rotation of the mount about the main axis.

2. The orbital welding system of claim 1, further comprising:
a drive gear coupled to the motor for selective rotation about a drive axis; and
a main gear fixedly positioned relative to the mount and engaging the drive gear such that rotation of the drive gear about the drive axis in a first direction rotates the welding torch about main axis in a second direction.

3. The orbital wending system of claim 1, wherein the clamp assembly is configured to center the flange along the main axis.

4. The orbital welding system of claim 1, wherein the clamp assembly comprises at least one clamping element, each of the at least one clamping elements including:
a clamp member rotatably coupled to the base about a clamp axis, rotation of the clamp member in a first direction about the clamp axis moving a first end of the clamp member toward the base;
and a drive element selectively positionable relative to the base and engaging the clamp member to selectively rotate the clamp member about the clamp axis.

5. The orbital welding system of claim 4, wherein each of the at least one clamping elements further includes a biasing element configured to urge the first end of the clamp member away from the base.

6. The orbital welding system of claim 5, wherein the drive element is a screw in threaded engagement with the base.

7. The orbital welding system of claim 1, wherein the clamp assembly comprises:
at least one elongate clamp element mounted to the base for rotation about a corresponding clamp axis, the clamp axis being parallel to the main axis; and
a drive element engaging each of the at least one clamp elements to selectively rotate the clamp element about the corresponding clamp axis between a clamped position and an unclamped position.

8. The orbital welding system of claim 7, wherein the drive element is a clamp ring mounted to the base for selective rotation about the main axis, the clamp ring driving each of the at least one clamp elements about the corresponding clamp axis.

9. The orbital welding system of claim 8, wherein the clamp ring includes at least one pin mounted thereto, each of the at least one pins extending through a slot formed in a corresponding one of the at least one claim elements, movement of each of the at least one pin around the main axis driving rotation of the corresponding clamp element about the corresponding clamp axis.

10. The orbital welding system of claim 9, further comprising a plurality of mounting tabs coupled to the base, each mounting tab limiting rotation of at least one of the clamp elements.

11. The orbital welding system of claim 9, wherein at least one handle extends radially from the clamp ring.

12. The orbital welding system of claim 11, further comprising a guide fixedly positioned relative to the base, the guide limiting rotation of the clamp ring about the main axis.

13. The orbital welding system of claim 1, wherein the welding torch is a TIG welding torch.

14. The orbital welding system of claim 1, wherein the rotation of the mount drives the electrode along a circular path.

15. The orbital welding system of claim 14, wherein the circular path is offset from the base.
